(19) United States
(12) Patent Application Publication
(10) Pub. No.: US 2009/0094633 A1
(43) Pub. Date: Apr. 9, 2009

(54) METHOD AND TERMINAL FOR RECORDING BROADCAST STREAM

(76) Inventors: Young-Jin CHOI, Suwon-si (KR); Young-Kyu Bae, Bucheon-si (KR); Young-Jip Kim, Suwon-si (KR); Byoung-Dai Lee, Seongnam-si (KR); Ji-Wuck Jung, Suwon-si (KR)

Correspondence Address: THE FARRELL LAW FIRM, P.C., 333 EARLE OVINGTON BOULEVARD, SUITE 701, UNIONDALE, NY, 11553, US

(21) Appl. No.: 12/247,732

(22) Filed: Oct. 8, 2008

(30) Foreign Application Priority Data
Sep. 10, 2007 (KR) 0101440/2007

(51) Int. Cl. H04N 7/16; H04N 7/173

(52) U.S. Cl. 725/28; 725/153; 725/134

(57) ABSTRACT

A method and a terminal for recording a broadcast stream so that, when the recorded broadcast stream is reproduced, a viewing restriction is placed. The method includes receiving a broadcast stream transmitted in real time and a message containing viewer rating information, and storing the viewer rating information together with the broadcast stream as a media file of a particular file at a broadcast stream recording request. When the stored broadcast stream is reproduced, the same viewing restriction is placed as when the broadcast is watched in real time.

### PRIORITY

This application claims priority under 35 U.S.C. §119(a) to an application filed in the Korean Intellectual Property Office on Oct. 9, 2007 and assigned Serial No. 2007-101440, the contents of which are hereby incorporated by reference.

### BACKGROUND OF THE INVENTION

1. Field of the Invention

The present invention generally relates to a method and a terminal for recording a broadcast stream, and more particularly to a method and a terminal for recording a broadcast stream so that, when the recorded broadcast stream is reproduced, a viewing restriction is placed.

2. Description of the Related Art

As generally known in the art, the mobile communication market is continuously requested to produce new services by recombining or integrating existing technologies. In line with the recent development of communication and broadcasting technologies, conventional broadcasting systems or mobile communication systems can now provide a portable broadcasting service through portable terminals, such as cellular phones, PDAs (Personal Digital Assistants), etc., referred to herein as mobile terminals. The combination of mobile communication services and IP (Internet Protocol) is now regarded as a main stream of the next-generation mobile communication development for a number of intermixed reasons, including potential and actual market demands, increasing user demands for multimedia services, business strategies for providing new services besides conventional voice communication services, and interests of IT (Information Technology) corporations in reinforcing the mobile communication business sector according to consumer demands. Furthermore, portable broadcasting services for providing broadcasting services via mobile terminals are undergoing extensive commercialization and standardization.

Examples of such standardization include a portable broadcasting technology standard established by OMA (Open Mobile Alliance), which has been organized to discuss and establish standards regarding international portable broadcasting technology. The standard, also referred to as OMA-BCAST (Open Mobile Alliance Mobile Broadcast), describes various methods for providing portable broadcasting services via portable broadcasting networks. The OMA-BCAST also regulates service and content protection standards for protecting broadcast contents of portable broadcasting services.

In order to protect broadcast contents, the broadcast transmission side encrypts broadcast contents and broadcasts them. Mobile terminals receive the encrypted broadcast stream and reproduce it in real time. In addition, mobile terminals can record a received broadcast stream and reproduce it later, or deliver it to other terminals. When a broadcast stream is recorded according to BCAST, which is one of portable broadcasting DVB-H (Digital Video Broadcast—Handheld) standards, the PDCF (Packetized DRM Content Format) file type is used for recording. The PDCF is one of DRM (Digital Rights Management) content formats for protecting continuous media (e.g. audio or video) by using OMA DRM 2.0, and is used to store a broadcast stream that is broadcasted according to BCAST, which is one of DVB-H standards. According to the PDCF, the transmission protocol side encrypts and transmits broadcast contents, which are re-encrypted, recorded, and stored. This format is based on the ISO (International Standardization Organization) file format for encrypted media contents, and is defined to support OMA DRM 2.0.

As mentioned above, when a broadcast stream is transmitted in real time according to BCAST, viewer rating information is transmitted together with the broadcast stream. When a mobile terminal receives and reproduces the broadcast stream, the viewer rating is taken into account. For example, the user of the mobile terminal is not allowed to watch the broadcast stream if he/she is not entitled to do so based on the received viewer rating.

As such, when a broadcast stream is transmitted to a mobile terminal in real time and reproduced by the mobile terminal, the viewer rating information transmitted together with the broadcast stream makes it possible to place a viewing restriction.

However, if a received broadcast stream is recorded as a PDCF media file, received viewer rating information is not stored together with the broadcast stream, i.e. the received broadcast stream is stored individually as a file. This means that no viewing restriction can be placed when the recorded broadcast file is reproduced later. In other words, a user of a mobile terminal can record a broadcast stream, which has a viewing restriction, and then reproduce the broadcast stream even if he/she is not entitled to watch the broadcast stream.

### SUMMARY OF THE INVENTION

Accordingly, the present invention substantially solves the above-mentioned problems occurring in the prior art, and provides a method and a terminal for recording a broadcast stream so that, when the recorded broadcast stream is reproduced, a viewing restriction is placed.

The present invention also provides a method and a terminal for recording a broadcast stream together with viewer rating information so that, when the recorded broadcast stream is reproduced, the reproduction can be restricted based on the same viewer rating as when the broadcast is watched in real time.

In accordance with an aspect of the present invention, there is provided a mobile terminal for recording a broadcast stream, the mobile terminal including a memory unit for storing a media file; a broadcast receiver for receiving a broadcast stream transmitted in real time and a message containing viewer rating information; and a controller for storing the broadcast stream as a media file of a particular format in the memory unit at a broadcast stream recording request so that the viewer rating information is added to the media file and stored together with the broadcast stream.

In accordance with another aspect of the present invention, there is provided a method for recording a broadcast stream by a mobile terminal, the method including receiving a broadcast stream transmitted in real time and a message containing viewer rating information; and storing the viewer rating information together with the broadcast stream as a media file of a particular file at a broadcast stream recording request.

### BRIEF DESCRIPTION OF THE DRAWINGS

The above and other aspects, features and advantages of the present invention will be more apparent from the following detailed description taken in conjunction with the accompanying drawings, in which:

FIG. 1 shows the structure of a PDCF media file, which is applied to the present invention;

FIG. 2 shows a format example of an OMA DRM common header contained in a PDCF media file;

FIG. 3 shows a format example of OMADRMAccessControlDescriptorBox contained in an extension header of the OMA DRM common header shown in FIG. 2 to store viewer rating information according to the present invention;

FIGS. 4A and 4B show the structure of an access control descriptor contained in the OMADRMAccessControlDescriptorBox shown in FIG. 3;

FIG. 5 shows descriptor examples having two pieces of viewer rating information according to the present invention;

FIG. 6 shows the internal construction of a mobile terminal adapted to place a viewing restriction on a recorded media file according to the present invention;

FIG. 7 is a control flowchart showing steps of recording a broadcast stream as a media file and storing viewer rating information together with the broadcast stream according to the present invention; and

FIG. 8 is a control flowchart showing steps of placing a viewing restriction when a recorded broadcast stream is reproduced according to the present invention.

### DETAILED DESCRIPTION OF THE PREFERRED EMBODIMENTS

Preferred embodiments of the present invention will now be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

The present invention provides a scheme for receiving a BCAST (Mobile Broadcast)-based broadcast stream by a mobile terminal, recording the received broadcast stream as a PDCF (Packetized DRM (Digital Rights Management) Content Format) media file, and storing viewer rating information, which is associated with the received broadcast stream, together with the received broadcast stream. The structure of a box included in the PDCF is modified and amended so that, when a broadcast stream transmitted in real time is recorded as a PDCF media file, viewer rating information associated with the corresponding broadcast can be stored together with the broadcast stream. The viewer rating information during real-time broadcast watching is transmitted to the mobile terminal in the type of a BCAST STKM (Short Term Key Message), and is stored as an access control descriptor in the access_descriptor field of the message. The viewer rating information stored as the access control descriptor includes age-based restriction information and region-based restriction information, for example.

The present invention also provides a scheme for placing a viewing restriction based on stored viewer rating information when a recorded broadcast stream is reproduced later.

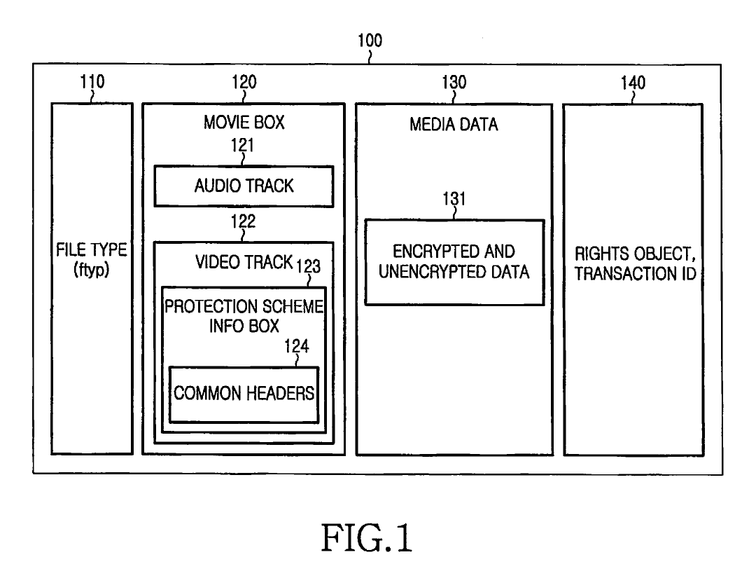

The structure of a PDCF media file used to store a received broadcast stream according to the present invention will be described with reference to FIG. 1. The PDCF media file includes a file type 110, a movie box 120 containing audio/video tracks, media data 130 including OMA DRM (Open Mobile Alliance DRM) protected content 131, and a right object/transaction ID 140 including a key necessary to decode the stream. The video track 122 includes a protection scheme info box 123 storing information regarding the corresponding stream, and the protection scheme info box 123 includes an OMA DRM common header 124. The protection scheme info box 123 stores information regarding the corresponding stream. Particularly, the OMA DRM common header 124 contained in the protection scheme info box 123 stores information necessary to decode contents. When a broadcast stream is received and recorded as a PDCF media file, viewer rating information associated with the received broadcast stream can be contained and stored in the OMA DRM common header 124.

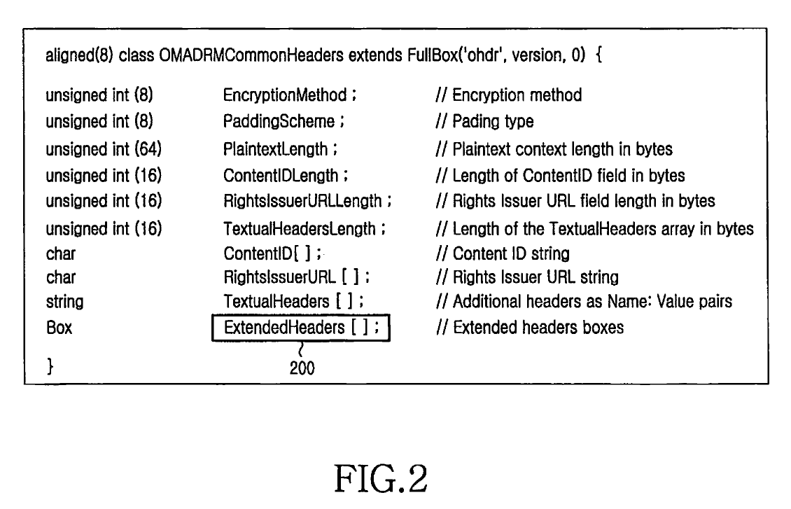

The DRM common header 124, which can store viewer rating information when a broadcast stream is recorded as a PDCF media file according to the present invention, is shown in FIG. 2. The DRM common header 124 has a box defined for future extension by placing “ExtendedHeaders[ ]” as labeled 200 in FIG. 2. That is, according to the present invention, viewer rating information associated with a recorded broadcast stream is stored in a box of the DRM common header 124, which has been reserved for future extension.

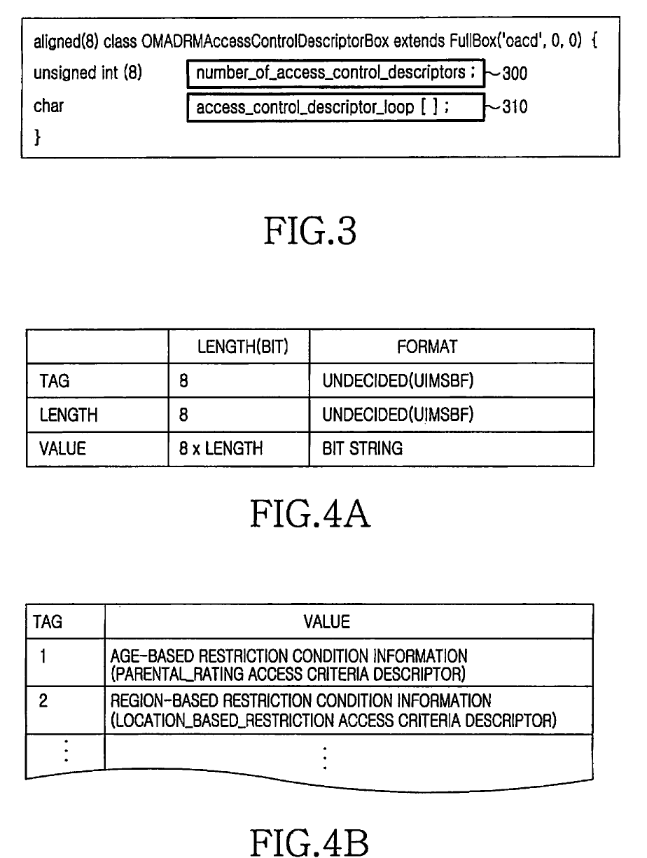

In addition, a STKM message associated with a received and recorded broadcast stream contains an access control descriptor including viewer rating information. When a mobile terminal receives the STKM message according to the present invention, the mobile terminal checks the number of access control descriptors. Furthermore, the mobile terminal uses an OMADRMAccessControlDescriptorBox (oacd box), which includes the checked number of access control descriptors and the descriptors. The OMADRMAccessControlDescriptorBox provided by the present invention is shown in FIG. 3, wherein reference numeral 300 refers to a portion containing the number of access control descriptors, and 310 refers to a portion containing an access control descriptor. The access control descriptor 310 has a structure as shown in FIGS. 4A and 4B.

Referring to FIGS. 4A and 4B, the descriptor 310 of FIG. 3 includes a tag field, a length field, and a value field as shown in FIG. 4A, and the value contained in the tag field tells what kind of restriction condition information is contained in the value field. For example, if the tag value is 1 as shown in FIG. 4B, age-based restriction condition information is contained, and if the tag value is 2, region-based restriction condition information is contained. Although two types of restriction conditions (i.e. age-based and region-based restrictions) have been described in connection with viewer rating information according to the present invention, other restriction conditions are also conceivable. Different tag values are assigned to additional restriction conditions, and the value field contains the corresponding restriction condition.

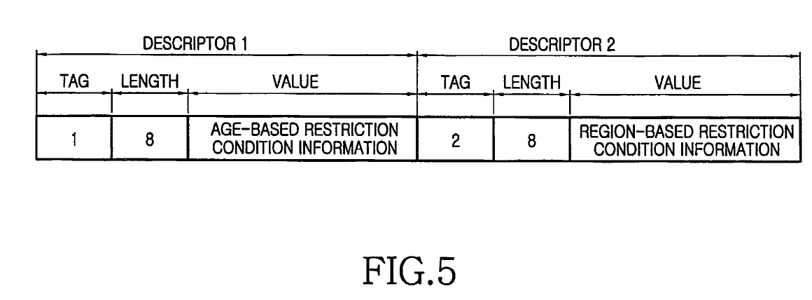

It will be assumed, for example, that an STKM message associated with the currently recorded broadcast stream contains descriptors regarding two conditions, i.e. descriptors regarding age-based and region-based restrictions, as shown in FIG. 5. When a mobile terminal receives this STKM message and records the corresponding broadcast stream, the terminal confirms that there are two descriptors in the OMADRMAccessControlDescriptorBox 300 of FIG. 3, and places the received descriptors of FIG. 5 in the access control descriptor 310 of FIG. 3. Then, the OMADRMAccessControlDescriptorBox containing the viewer rating information is contained and stored in the OMA DRM common header 124 of FIG. 1.

As such, the OMADRMAccessControlDescriptorBox shown in FIG. 3 is added to the extended header box of the DRM common header 124 so that, when a broadcast stream transmitted in real time is recorded as a PCDF media file, viewer rating information is added to the recorded media file.

When the media file recorded in this manner is reproduced, the viewer rating information of the oacd box stored in the PDCF header is used to place the same viewing restriction based on the age or region as when the broadcast is watched in real time.

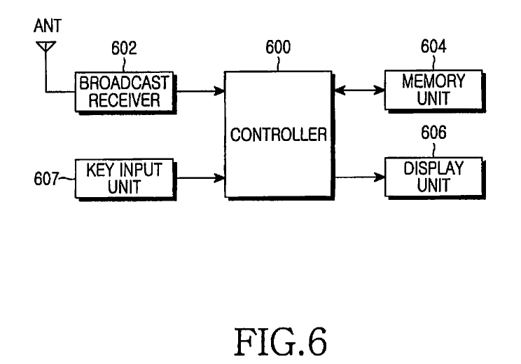

The internal construction of the mobile terminal, which is adapted to record a broadcast stream received in real time as a PDCD media file and store the broadcast stream together with viewer rating information, will now be described with reference to FIG. 6. A mobile terminal according to the present invention includes a broadcast receiver 602 for receiving a broadcast stream, a memory unit 604, a display unit 606, a key input unit 607, and a controller 600.

The controller 600 controls the overall operation of the mobile terminal. Particularly, when requested to record a broadcast stream broadcasted in real time, not only the received broadcast stream is stored, but also viewer rating information associated with the broadcast stream is stored together with the broadcast stream under the control of the controller 600.

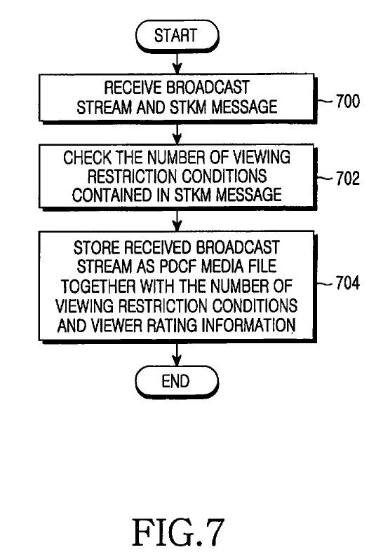

Operation of recording a broadcast stream by the controller 600 will now be described with reference to FIG. 7. The controller 600 receives a broadcast stream and an associated STKM message in step 700, and checks the number of viewing restriction conditions contained in the STKM message in step 702. More particularly, the number of viewing restriction conditions is checked by counting the number of access control descriptors contained in the BCAST STKM message transmitted together with the broadcast stream. The controller 600 stores the received broadcast stream as a PDCF media file, and adds the number of viewing restriction conditions and the viewer rating information to the stored media file in step 704. Step 704 will be described in more detail with reference to FIGS. 1-3. The controller 600 adds the checked number and the descriptors to the “oacd” box as shown in FIG. 3, more particularly, to “ExtendedHeaders” of FIG. 2 of the OMA DRM common header 124 of the PDCF media file 100 of FIG. 1.

As such, a media file is stored together with viewer rating information, and if the stored media file is to be reproduced, the controller 600 checks the viewer rating information contained in the media file and, based on the checked viewer rating information, places the same viewing restriction as when the broadcast is watched in real time.

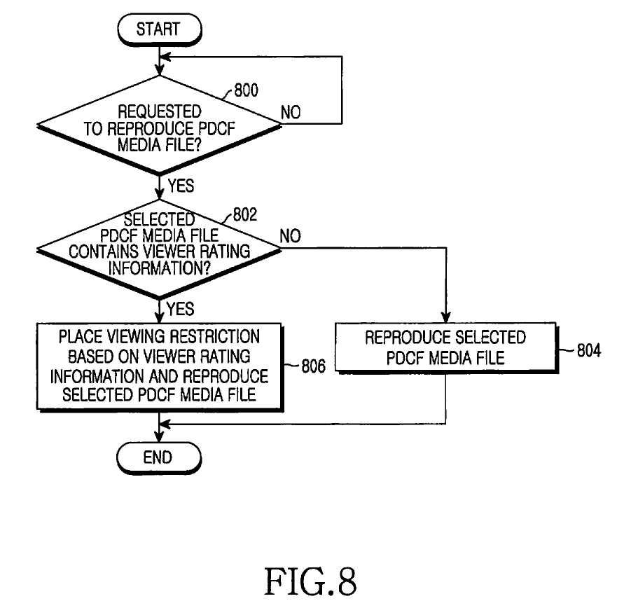

Operation of reproducing a broadcast stream, which has been recorded through the process shown in FIG. 7, by the controller 600 will now be described with reference to FIG. 8.

The controller 600 checks whether it is requested that the PDCF media file be reproduced in step 800. If so, the controller 600 proceeds to step 802 and confirms whether the media file to be reproduced contains viewer rating information. Step 802 will be described in more detail with reference to FIGS. 1-3. When a certain PDCF media file is to be reproduced, the controller 600 determines whether the extension header 200 of the OMA ERM common header 124 contains an oacd box as shown in FIG. 3. If it is determined that an oacd box is contained, i.e. viewer rating information is contained, the controller 600 proceeds to step 806, in which the controller 600 places a viewing restriction based on the viewer rating information and reproduces the selected media file. That is, the controller 600 reads the access control descriptor of the oacd box and places the same viewing restriction as when the broadcast is reproduced in real time.

If it has been confirmed that the OMA DRM common header 124 contains no oacd box. i.e. no viewer rating information is contained, the controller 600 proceeds to step 804 and reproduces the selected media file.

As mentioned above, the method and terminal for recording a broadcast stream according to the present invention is advantageous in that, when a recorded broadcast stream is reproduced, the same viewing restriction is placed as when the broadcast is watched in real time. Consequently, when a user of a mobile terminal has recorded a broadcast stream having a viewer restriction, he/she can reproduce and watch the recorded broadcast stream only if he/she is entitled to do so based on the viewer

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A mobile terminal for recording a broadcast stream, the mobile terminal comprising:
a memory unit for storing a media file;
a broadcast receiver for receiving a broadcast stream transmitted in real time and a message containing viewer rating information; and
a controller for storing the broadcast stream as a media file of a particular format in the memory unit at a broadcast stream recording request so that the viewer rating information is added to the media file and stored together with the broadcast stream.

2. The mobile terminal as claimed in claim 1, wherein, when requested to reproduce the media file stored in the memory unit, the controller confirms whether the media file contains viewer rating information, and, when the viewer rating information is contained, the controller places a viewing restriction based on the viewer rating information and reproduces the media file as requested.

3. The mobile terminal as claimed in claim 2, wherein the viewer rating information comprises at least one restriction condition information.

4. The mobile terminal as claimed in claim 3, wherein the broadcast stream is a BCAST (Mobile Broadcast)-based broadcast stream, the particular format is PDCF (Packetized DRM (Digital Rights Management) Content Format), and the at least one restriction condition information is stored in the message containing the viewer rating information as a descriptor corresponding to each restriction condition information.

5. The mobile terminal as claimed in claim 4, wherein the controller checks a number of viewing restriction conditions from the message containing the viewer rating information at the recording request, and stores the checked number of restriction conditions in the media file together with the viewer rating information.

6. The mobile terminal as claimed in claim 5, wherein the number of viewing restriction conditions is checked by counting a number of descriptors contained in the message containing the viewer rating information.

7. The mobile terminal as claimed in claim 6, wherein the controller stores the viewer rating information and the number of viewing restriction conditions in a field reserved for extension in a common header of the media file.

8. The mobile terminal as claimed in claim 7, wherein, when the viewer rating information is stored, the controller stores the at least one descriptor contained in the received message containing the viewer rating information.

9. The mobile terminal as claimed in claim 7, wherein, when the controller confirms whether the media file contains viewer rating information, reproduction of the media file having been requested, the controller confirms whether the viewer rating information and the number of viewing restriction conditions are stored in the field reserved for extension in the common header of the media file.

10. A method for recording a broadcast stream by a mobile terminal, the method comprising the steps of:
receiving a broadcast stream transmitted in real time and a message containing viewer rating information; and
storing the viewer rating information together with the broadcast stream as a media file of a particular file at a broadcast stream recording request.

11. The method as claimed in claim 10, further comprising:
confirming whether the stored media file contains viewer rating information when it has been requested that the media file be reproduced; and
placing a viewing restriction based on the viewer rating information and reproducing the media file upon confirmation that the media file contains viewer rating information.

12. The method as claimed in claim 11, wherein the viewer rating information comprises at least one restriction condition information.

13. The method as claimed in claim 12, wherein the broadcast stream is a BCAST (Mobile Broadcast)-based broadcast stream, the particular format is PDCF (Packetized DRM (Digital Rights Management) Content Format), and the at least one restriction condition information is stored in the message containing the viewer rating information as a descriptor corresponding to each restriction condition information.

14. The method as claimed in claim 13, wherein the storing step comprises:
checking a number of viewing restriction conditions from the message containing the viewer rating information at the broadcast stream recording request; and
storing the checked number of restriction conditions in the media file together with the viewer rating information.

15. The method as claimed in claim 14, wherein, in the step of checking a number of viewing restriction conditions, a number of descriptors contained in the message containing the viewer rating information is counted.

16. The method as claimed in claim 15, wherein, in the step of storing the checked number of restriction conditions in the media file together with the viewer rating information, the viewer rating information and the number of viewing restriction conditions are stored in a field reserved for extension in a common header of the media file.

17. The method as claimed in claim 15, wherein, in the step of storing the checked number of restriction conditions in the media file together with the viewer rating information, the number of viewing restriction conditions and at least one descriptor contained in the received message containing the viewer rating information are stored in a field reserved for extension in a common header of the media file.

18. The method as claimed in claim 17, wherein, in the step of confirming whether the media file contains viewer rating information, reproduction of the media file having been requested, confirmation is obtained whether the viewer rating information and the number of viewing restriction conditions are stored in the field reserved for extension in the common header of the media file.
